(19) United States
(12) Patent Application Publication
(10) Pub. No.: US 2015/0242815 A1
(43) Pub. Date: Aug. 27, 2015

(54) ADAPTIVE WORKFORCE HIRING AND ANALYTICS

(71) Applicant: ZOOM INTERNATIONAL s.r.o., Prague 8 (CZ)

(72) Inventor: Moses Velasco, Prague (CZ)

(73) Assignee: ZOOM INTERNATIONAL s.r.o., Prague 8 (CZ)

(21) Appl. No.: 14/187,205

(22) Filed: Feb. 21, 2014

(51) Int. Cl. G06Q 10/10; H04L 29/08

(52) U.S. Cl. CPC G06Q 10/1053; H04L 67/10

(57) ABSTRACT

A system for adaptive workforce hiring and analytics, comprising a network-connected web server, an application server, an analysis server, and a database, wherein the web server receives data communications across a network, the application server provides interactive management of system components, the analysis server performs analysis operations on received data, and the database stores data and analysis results, and a method for providing modular workforce management.

### CROSS-REFERENCE TO RELATED APPLICATIONS

None.

### BACKGROUND OF THE INVENTION

1. Field of the Art

The disclosure relates to the field of workforce management, and more particularly to the field of analyzing members and potential members of a workforce using adaptive analytics.

2. Discussion of the State of the Art

In the field of workforce management, it is common to track or measure workforce members (such as employees of a contact center), for example such as monitoring performance according to a set of metrics such as to represent performance efficiency or other statistics that may be relevant to management. For example, in a contact center setting it is common to score contact agents based on call performance metrics such as handle time, customer satisfaction, or number of calls handled in a given working period.

While it is common to measure individual members or groups according to their performance, such grading traditionally is used for making determinations regarding additional training, organizing agents based on performance or abilities, or making decisions regarding termination of workforce members due to performance issues. It can be appreciated that it may also be desirable to grade employees to make hiring decisions, such as measuring those who show similar characteristics to those of employees known to be high performing employees, or measuring potential for upward or lateral movement, or determining relevant scoring information to determine whether an individual may be a good candidate for hire.

Additionally, once metrics are used for hiring decisions an additional use may be that of measuring results of such hiring decisions—that is, tracking new hires to see how successful the determinations were, or making organizational observations such as measuring the difference between hires based on one metric as compared to another, or from one source as compared to another.

Additionally, such a metric-based approach could benefit greatly from utilizing existing or new services in the art, for example third-party workforce services such as MONSTER.COM™, or social networking services such as FACBEOOK™ or LINKEDIN™, for example such as to observe an individual prior to making a hiring decision.

### SUMMARY OF THE INVENTION

Accordingly, the inventor has conceived and reduced to practice, in a preferred embodiment of the invention, a system and method for adaptive workforce analytics.

According to a preferred embodiment of the invention, a system for adaptive workforce analytics comprising a network-connected web server, an application server, an analysis server, and a database, is disclosed. According to the embodiment, a web server may connect to the Internet or other communications network, and may receive and respond to communications over a network such as to provide interaction between individual components of a system as well as handling external communications (that is, communicating with external components, services, or devices that may be network-connected for communication). An application server may operate and provide interactive software applications or other software means for facilitating operation of a system, such as an interactive interface for a human operator to manually configure the behavior or otherwise control or manage the operation of individual components of a system according to the invention, or any other such interactive means as may be appropriate according to a particular arrangement. A database may be any physical or software-based data storage medium such as integral or removable storage media, for example such as removable optical or magnetic storage devices, or software-based storage schema such as MYSQL™ or other database schema, as are common in the art.

According to an additional embodiment, a system for adaptive workforce analytics may further comprise a software application programming interface (“API”), such as is common in the art and may be utilized to allow third-party products or services to be utilized in conjunction with the functionality or operation provided by the system of the invention. For example, utilizing such an API a modular workforce management system may be connected to existing workforce services such as call monitoring systems for recording and scoring employees, resume services such as MONSTER.COM™, or social networking services such as LINKEDIN™ or FACEBOOK™. In this manner, information available through such products or services may be made available to a system according to the invention for use during operation, such as monitoring an employee's performance using existing metric systems or doing research on potential candidates for hire by reviewing their available social networking profiles.

By incorporating third-party services as described above, it becomes possible to identify potential candidates for hire based on observed relationships or shared characteristics (such as those revealed by analysis on existing employees). It may then become possible to use analysis results for “headhunting” operations, or seeking out new hires based on anticipated performance regardless of whether they have actually expressed a desire for employment (i.e., rather than wait for an individual to seek out employment, an employer may proactively reach out to them via a social networking service to express their desire to hire that individual, and it then becomes up to the individual whether to accept).

According to another preferred embodiment of the invention, a method for providing adaptive workforce analytics, comprising the steps of connecting to a plurality of data sources (such as new or existing workforce management systems or services), receiving data from sources (such as employee performance information or social networking posts collected on potential new hires), storing data for future use (such as for comparison with newly received data at a later time), performing analysis on the data (such as to identify trends or groupings from the data), and storing and optionally presenting analysis results to a human reviewer for interpretation or study. In this manner, it can be appreciated that data may be collected for use immediately or stored for future reference such as during comparison operations, as may be desirable to compare known historical data with newly-received data to identify any changes or trends that may be occurring. Such analysis may also be used to identify similarities or grouping information, such as identifying traits common to employees displaying certain performance characteristics or efficiency levels, and may further be used to score potential new hiring candidates based on known information such as observing that they share traits or behavior patterns with known workforce groups (such as displaying similar behavior as known high performers, or having similar personal preferences as those that excel in a particular field).

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an exemplary system architecture for modular workforce management, according to a preferred embodiment of the invention.

FIG. 6 is a method flow diagram of an exemplary method for providing modular workforce management, according to a preferred embodiment of the invention.

FIG. 7 is a method flow diagram of a broad overview process for adaptive analysis according to the invention.

### DETAILED DESCRIPTION

The inventor has conceived, and reduced to practice, a system and method for adaptive workforce analytics.

One or more different inventions may be described in the present application. Further, for one or more of the inventions described herein, numerous alternative embodiments may be described; it should be understood that these are presented for illustrative purposes only. The described embodiments are not intended to be limiting in any sense. One or more of the inventions may be widely applicable to numerous embodiments, as is readily apparent from the disclosure. In general, embodiments are described in sufficient detail to enable those skilled in the art to practice one or more of the inventions, and it is to be understood that other embodiments may be utilized and that structural, logical, software, electrical and other changes may be made without departing from the scope of the particular inventions. Accordingly, those skilled in the art will recognize that one or more of the inventions may be practiced with various modifications and alterations. Particular features of one or more of the inventions may be described with reference to one or more particular embodiments or figures that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described, it will be readily apparent that more than one device or article may be used in place of a single device or article. Similarly, where more than one device or article is described, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be noted that particular embodiments include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be disclosed herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, and the like), a consumer electronic device, a music player, or any other suitable electronic device, router, switch, or the like, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or the like).

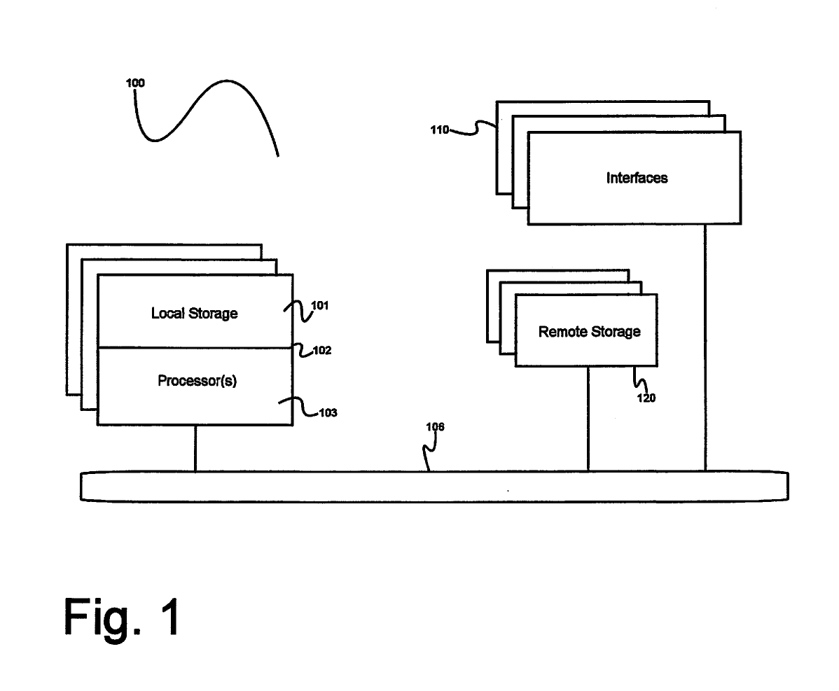

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, Firewire™, PCI, parallel, radio frequency (RF), Bluetooth™ near-field communications (e.g., using near-field magnetics), 802.11 (WiFi), frame relay, TCP/IP, ISDN, fast Ethernet interfaces, Gigabit Ethernet interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include ports appropriate for communication with appropriate media. In some cases, they may also include an independent processor and, in some in stances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory, solid state drives, memristor memory, random access memory (RAM), and the like. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

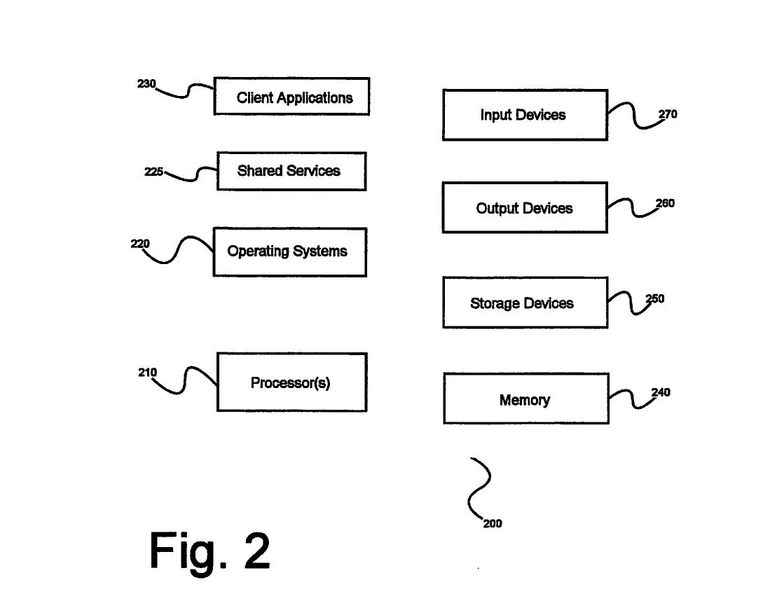

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's Windows™ operating system, Apple's Mac OS/X or iOS operating systems, some variety of the Linux operating system, Google's Android™ operating system, or the like. In many cases, one or more shared services 225 may be operable in system 200, and may be useful for providing common services to client applications 230. Services 225 may for example be Windows™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form. Examples of storage devices 250 include flash memory, magnetic hard drive, CD-ROM, and/or the like.

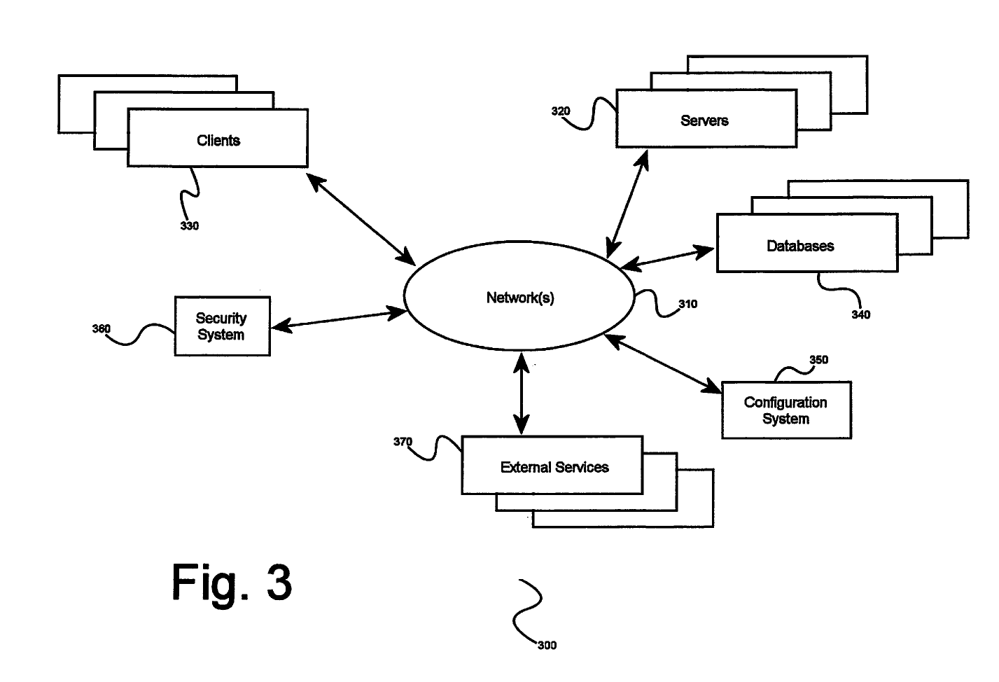

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network, a wireless network (such as WiFi, Wimax, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

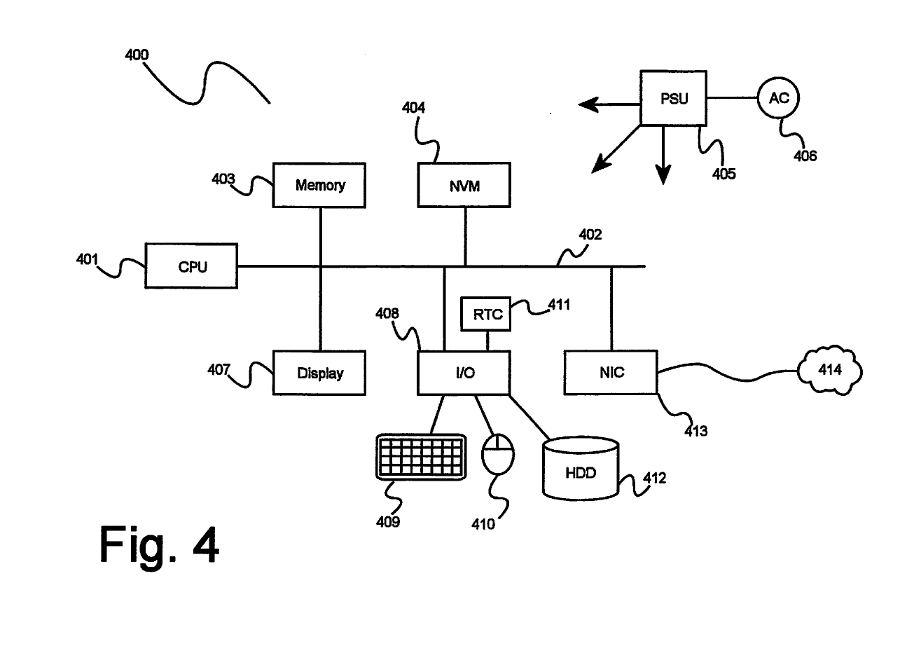

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein.

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

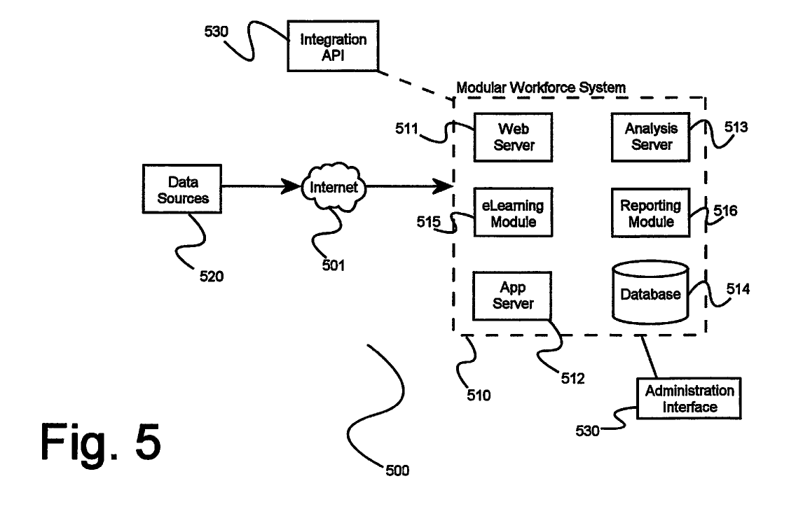

FIG. 5 is a block diagram of an exemplary system 500 for adaptive workforce analytics, according to a preferred embodiment of the invention. As illustrated, a system 500 may comprise a modular workforce management system 510 that may be connected to the Internet or other communications network 501, such as to communicate with or receive data from a plurality of external data sources 520, such as workforce monitoring or measuring systems or services as are common in the art. As illustrated, a workforce management system 510 may further comprise a network-capable web server 511 that may receive or respond to communication from other network-connected components or devices, an application server 512 that may provide interactive software or other means such as for a human operator to configure settings or operation of components of a system 510, an analysis server 513 that may perform analysis operations on data received from other components, a database 514 that may be utilized such as to store data for future use by components (such as for performing analysis operations on previously-stored historical data), an eLearning module 515 that may be utilized for such purposes as providing virtual learning aids or training exercises (such as to receive interaction from a connected user, as described below), and a reporting module 516 that may generate and provide reports of system operation or activities. Additionally, an administration interface 530 may be connected to (or an integral component of) system 500, such as via a direct or network connection and for such purposes as configuration or management of system operation or behavior, as described below.

According to the embodiment, data (such as observed performance metrics or other quantifiable data regarding members of a workforce) may be received from a variety of external sources 520 such as call recording systems, time tracking systems, resume collection or hosting services, or any other such system or service that may be useful or relevant to analyzing members or groups of a workforce. In some embodiments, services according to the invention may also collect resumes directly from applicants via a website, and ingest them therefrom directly into the system for analysis. According to the invention, collection of resumes (whether directly from applicants or from third party services) allows the storage and analysis of large numbers of resumes. Not all resumes will be appropriate for hires by a given enterprise, but possession and analysis of a large number of resumes (suitable and not) will allow the enterprise to analyze a wide range of resumes to discover patterns that may be leveraged in the hiring process. This data may then be used, for example, by an analysis engine 513 such as to identify patterns or trends (such as observing that employees with certain traits exhibit certain performance metrics), such as may be useful for grouping or organizing workforce members or candidates, as well as to identify connections (such as causal relationships) between various metrics or data points and performance indicators. For example, by monitoring various existing systems or services (such as call recording systems, time/clock tracking systems, or other such systems as are common in the art), analysis might reveal that employees with particular call handling traits (such as tone of voice, vocabulary used, or various commonly-tracked or scored metrics such as handle time or hold time) also display particular performance indicators such as a higher-than-average customer satisfaction rating based on survey results (as are commonly tracked in the art). In this manner, analysis may reveal correlations between factors that might ordinarily go unnoticed or untracked (such as tone of voice during a customer interaction) and employee performance, forming more relevant connections and identifying relationships not otherwise possible via traditional metric scoring methods common in the art. Furthermore, it should be appreciated that such analysis may also reveal more complex connections such as by identifying relationships between various metrics (for example, analysis might reveal that employees who have a calm tone of voice during calls also exhibit a more complex vocabulary), which might then be further connected to additional metrics (employees with complex vocabulary might also display a shorter call handle time), forming indirect relationships and tying various metrics together that may otherwise be seen as unrelated in traditional methods (therefore, continuing the previous examples, it may be inferred that employees with a calm tone of voice are more likely to have short call handle time, which is often a desirable trait in contact center operations).

Utilizing such metric relationships and data connections as described above, it becomes apparent that advanced candidate screening becomes possible (as well as performance analysis of existing employees), as well as more accurate predictions based on known information regarding candidates, workforce members, or groups. Utilizing such information, it then becomes possible to perform analysis of potential new hires (such as via resume analysis) to determine anticipated performance. For example, analysis might be performed over a set of received resumes from potential new employees, to compare against known information from analysis of an existing workforce to determine how they compare in terms of various analyzed information and relationships. For example, continuing a prior example, it may be determined that select resumes show a more complex vocabulary than average, which may (based on prior analysis, as described previously) indicate that those candidates will also display a shorter call handle time, potentially making them more desirable for hire. As another example, resumes may be screened for specific word patterns that have been determined from performance analysis of existing employees to be associated with poor (or good) customer service interactions, thereby identifying poor (or good) candidates automatically (generally, a combination of such analyses and effects would be used to develop automated aggregate scores for a large number of candidates, which scores can for example be used to discard unpromising candidates, to identify very promising candidates and suggest immediate interviews or other actions, and to identify potentially good candidates who can be contacted for more information or scheduled for later interviews in case the most promising candidates either don't “pan out” or are too few). Typical profiles of desirable candidates, based for example on demographic information associated with good performance, semantic matching such as that just described, or matching of answers to standard questions (where answer groups that are associated with successful employees may be known), may be generated and stored so that, as new candidates enter the system they may be quickly and automatically screened and classified as (for example): “must interview”, “interview at leisure”, or “long shot”, “don't interview ever”, and so forth. In a preferred embodiment of the invention, hiring managers and human resources professionals are provided with a search engine interface that allows them to search for candidates based on criteria determined from automated resume parsing and analysis, demographic data, and so forth.

In some embodiments, regular reports may be produced by a reporting module 516 and provided to hiring managers and human resources professionals (although of course these are merely exemplary; such reports can be delivered to anyone who needs them), comprising for example aggregate information on a current candidate pool, rate of new candidate additions, demographic breakdowns of a current candidate pool, screening results of a current candidate pool, and recommended actions based on the screening results (for example, a list of recommended interviews for the coming week). Similarly, the system may automatically send responses to candidates when they submit their resumes or inquire about jobs, including such information as whether their information is complete, whether there are jobs available for which they might qualify, and the like. Of course, such “reports” to candidates will in general be simpler than those provided internally to hiring and human resources staff. In some embodiments, an appropriate demurrer may be provided to those candidates whose automated screening results indicate a “no hire” decision, while encouraging feedback may be provided to those whose results indicate a “must hire” decision (for example, by suggesting specific interview times, or confirming that the candidate will be contacted shortly to schedule an interview).

It should be further appreciated that analysis operations may utilize and benefit from machine learning, that is they may incorporate all prior and current analysis results to increase relevancy and efficiency of future operations. For example, continuing the example above, after performing analysis of a group of resumes for new hire candidates, additional new data relationships or potentially relevant metrics may be identified. This new information may then be used in future analysis of both existing and potential workforce members or groups, adding to the “pool” of relevant information that may be used in analysis. In this manner, any such decisions or management operations may be more relevant by having the benefit of known data collected across a workforce to use as a base for decision-making, and such data may also be stored in a database 514 for future use to enable to comparison of previously-observed data with newly-collected data, such as to identify changes or trends in a workforce or its members.

A further key feature of such data collection and analysis, is that of “grouping” workforce members based on identified relationships. For example, it may be determined that certain employees are known “high performers”, and they may be grouped together based on their performance scores. Analysis might then be performed to determine any similarities or relationships between these members, such as might be used to determine “why” or “how” they are high performers. For example, it may be observed that they all share certain personality characteristics, or have connections outside the workplace or in their personal life (such as attending the same school, or being from a similar birthplace). This information may then be used in analysis of potential new candidates as described previously, such as to determine whether any particular candidate is likely to also be a high performer based on how well they “match” known performance indicators based on prior analysis (for example, “did they go to this school?” or “do they have similar personal interests as known high performers?”). In this manner, hiring decisions may be improved by selecting candidates based on anticipated performance, as determined by how closely they compare to known high-performers, thereby reducing the risk of hiring ineffective or low-performing workforce members.

Further expanding on the use of collected and analyzed information regarding a workforce, this data may be used for further analysis (such as may be performed by an analysis server 513). Such analysis may be designed to identify trends or other links between employees or groups, such as identifying trends among employees sharing certain characteristics (“everyone who went to college A exhibits more proactive behavior than those who went to college B”, for example). Such analysis may be performed on any potentially-useful set of data, and may range from very general to very specific. The results of such analysis may then be used for consideration when making new hiring or recruiting decisions, for example seeking out new hires that match identified trends, or lateral transfers such as to rearrange employees to optimize performance based on analysis results (for example, moving employees to new shifts that have been shown to increase productivity in others with similar characteristics).

It should be appreciated that such analysis may be very beneficial during a hiring process, as now an employer may make more informed decisions regarding selection, such as by comparing potential candidates against known analysis results to only hire those with desirable performance or other characteristics (for example, an employer might hire a new member that is thought to improve productivity of an entire group based on analysis). It should be further appreciated that additional analysis may be continually performed on additional sets of data, such as analyzing a group of employees, then incorporating those analysis results into an analysis operation performed on a larger group (such as to identify relationships between subsets of employees within a larger group), or performing analysis on select employees as a subset (such as to determine shared characteristics between high-performers from multiple groups).

As further illustrated, an eLearning module 515 may be utilized, such as for screening or other purposes during operation. For example, an eLearning module 515 may provide interactive or informational training content (such as learning material, exercises to be performed, or any other interactive or non-interactive electronic content) such as to a potential hire candidate. Such content may be provided via a variety of means, such as sending a candidate a prompt (such as a clickable web URL) to their email address (such as might have been identified when their resume or application was screened). In this manner, potential candidates may be presented with further material to aid in a screening or hiring process, and such material may be presented via their preferred method to prevent giving the impression of “spam” or unwanted solicitation (which might impact their disposition toward the content provider, typically a company looking to hire them). An example of such operation may be the sending of a web URL to a candidate's email address, requesting that the candidate click the link to continue with their application process. Upon clicking the link, a new webpage is opened in their browser with a series of training exercises related to the specific job criteria or duties they applied for or are under consideration for, and generally designed to test and measure their skill level or training potential. As they complete these activities, they become more familiar with the materials and tasks that may be involved in the job in question, and their results are stored for further use, such as for scoring (to filter, sort, or otherwise group candidates) or for use in report generation, as described below. In this manner, it can be appreciated that the use of eLearning materials may be beneficial both to a prospective hire as well as the company considering hiring them, as both parties may gain insight into the other during the process.

As further illustrated, a reporting module 516 may be utilized such as for the generation of human-readable reports relevant to system operations. Exemplary report content might include (but is not limited to) details or statistics regarding operation of the system or components thereof, or information relevant to specific operations such as details of a candidate's eLearning performance or resume information. Reports may be stored for future reference as well as optionally presented to an administrator or other user connected to the system via an administration interface 530. In this manner, reports may be viewed “live”, or as they are generated, or may be retrieved and viewed at a later date. Additionally, an administration interface 530 may be used to configure and control operation of a system 500 or components thereof, such as to configure criteria for analysis operations or to configure eLearning behavior (such as to add new material or change scoring parameters, for example).

As further illustrated, an optional integration API 530 or similar integration interface or system may be utilized, such as to enable the integration and operation of a workforce management system 510 with existing third-party products or services such as social networking services (such as LINKEDIN™ or FACEBOOK™), or existing workforce systems such as call recording systems that may already be in place. Such integration may ease the cost of adoption, enabling the use of existing systems rather than requiring new ones, as well as increasing the breadth and relevancy of system operations by allowing the use of a greater variety and quantity of data for collection and analysis. For example, employee social network posts may be monitored to identify changes or trends, or to identify characteristics that may be common to various workforce members (such as observing that certain employees may share personal interests, and observing that they also share certain performance indicators), allowing for more relevant trend and grouping analysis operations.

It can be appreciated that by incorporating third-party services in analysis operations as described above, additional relationships and data sets may be gathered to further improve operation. For example, analysis might now reveal relationships between employees based on social network information (“employees with at least X followers have more creative ideas”). Further analysis may be performed to identify relationships between particular third-party services for additional use during hiring operations, such as (for example) identifying specific services or characteristics collected from those services that may be linked to performance (such as by comparing to previously-stored analysis results). For example, if previous analysis had identified specific high-performing employees, social networking information may be collected and utilized in a new analysis operation to identify shared characteristics or relationships between these employees, such as might be used to identify “why” or “how” they have higher performance. The findings of such analysis might then be used to select or seek out new hires that share such characteristics, in order to optimize such hiring decisions and avoid adding new employees with lower performance.

Additional information may be made available through the integration of third-party services such as employee social networking profiles (such as TWITTER™, FACEBOOK™, or LINKEDIN™). For example, individual posts or profile information may be analyzed and taken into consideration when identifying connections, such as analyzing not only an individual's number of followers but also detailed information about their “style” such as vocabulary (“are they professional in their posts?”) or personal information such as profile data (many social networks allow individuals to upload detailed personal information, and such information may be used in analysis). In this manner, workforce members may be analyzed and grouped based not only on their performance at the workplace (as described previously) but also based on their online presence and personal life—and it should be appreciated that when such additional information is made available for analysis, it can greatly improve analysis results such as grouping individuals or forming relationships between metrics or performance indicators. For example, to continue a prior example, a group of know high-performing employees might be analyzed with regard to their social network presence, potentially revealing additional personal information (such as personal info in their networking profile that may have been previously unknown to an employer), relationships with other individuals, or other potentially relevant data such as mannerisms or behavior characteristics displayed in their online postings or interactions with others via the social networks under analysis. In this manner, more precise information may be gathered that would not be possible via traditional methods, by incorporating information outside the workplace to identify connections and relationships through adaptive analysis of all available information related to the workforce members.

Using such analysis results and information made available from third-party services such as social networks, it then becomes possible to further improve a screening or analysis process for new hire candidates by then analyzing such candidates according to their third-party information, such as to determine any similarities or whether they match known trends or relationships for performance indicators. For example, again continuing a prior example, a group of resumes from potential new hires may be used to analyze each candidate's social network presence (for example, each candidate's LINKEDIN™ profile). Analysis may then reveal additional indicators such as whether they have connections with other known individuals (such as personal relationships with existing employees, or other individuals previously known through analysis such as family members, friends, or contacts revealed during previous analysis operations), or they might display certain behavior traits (such as their vocabulary, personality traits when interacting with other individuals via the social network, or other behaviors or traits that may be determined to be relevant), as might be relevant to a hiring process. For example, it might be observed that particular candidates are close friends with known high-performers (potentially making them more desirable for hire), or they may display frequent use of profanity in their interactions with other individuals via the social network (potentially making them less desirable).

It may be appreciated that by incorporating analysis of third-party services such as social networking services or resume-collection or hosting services such as MONSTER.COM™, it becomes possible not only to analyze these services during screening of potential new hires, but also to perform analysis operations on data from these services to seek out desirable candidates for hire. For example, a collection of resumes may be collected from a hosting services such as MONSTER.COM™, and analysis may be performed to process these resumes and search for individuals that are anticipated to be high performers in a workforce, in what may be seen as an adaptive analytics headhunting operation. In this manner, an employer might proactively seek out or “headhunt” individuals that may be desirable candidates for hire, even if they have not directly applied for or even expressed an interest in consideration. Furthermore, social networking profiles such as LINKEDIN™ may be analyzed such as to identify individuals that may be desirable for hire, such as by performing analysis of publicly-available profiles or by analyzing contacts or connections from previously-analyzed individuals. For example, an individual may have sent a resume to an employer, and this resume was then analyzed. As part of an analysis operation, their LINKEDIN™ profile may have also been analyzed, and their personal and professional contacts may have been made available for further analysis. Additional analysis could then be performed on each contact's profile (and in turn, their contacts and connections), increasing the “pool” of candidates as well as the complexity and precision of observed data and relationships. In this manner, an employer may always seek out the “best”, most qualified, or most likely to perform candidates when making a hiring decision, and may also be enabled to seek out or “headhunt” new hires based on their qualifications or anticipated performance, with a much larger scope than ordinarily possible according to traditional methods.

Additionally, as described previously, analysis may be continually performed on new or additional data sets, optionally incorporating previous analysis results, such that analysis operations may continually improve in their scope and relevancy. By adding new data sets (such as newly-collected information from third-party services, or newly-observed information on employees), analysis may reveal not only relationships between particular employees or characteristics, but also relationships between changes in these data points. For example, performing analysis on a group after the addition of a new hire (such as, for example, one hired based on analysis predictions that they would be a high-performer due to shared characteristics with known high-performers already present), the exact scope and nature of any changes brought about by their addition may be revealed. For example, it may turn out that they do not actually improve performance of the group, possibly due to a previously-unknown additional characteristic that can now be revealed through additional analysis, and therefore considered in future analysis operations to improve their results.

For example, in addition to performing analysis on individual new hire candidates as described previously (such as to determine anticipated value of a candidate for making a hiring decision), analysis may also be performed on their social networking profiles such as to determine the value of a particular social network in making such determinations. For example, it may be known from prior analysis that individuals may be high-performers regardless of their use of profanity in a particular social network (such as FACEBOOK™), which may be incorporated in future analysis operations as making that particular metric (use of profanity in a particular social network, or in social networks in general) less relevant for determinations. In this manner, not only may the metrics themselves be used in analysis of potential new hires, but also the source of these metrics may be taken into consideration such that analysis may be kept as relevant as possible by observing and incorporating the relative relevancy of any particular metric or data source. For example, it might be determined that all data collected from LINKEDIN™ is more relevant than data collected from FACEBOOK™, based on prior analysis results and observed performance (for example, it may have been predicted that an employee would be a low-performer based on the analysis of their FACEBOOK™ profile, but they proved to have high performance and after additional analysis it was determined that their LINKEDIN™ profile was an indicator of high performance despite their FACBEOOK™ profile indicating the contrary). In such cases, in some embodiments it will be desirable to weight candidates and/or screening results from some sources (such as LINKEDIN™ in the example just given) more heavily to reflect their higher quality, and similarly to discount inputs from unreliable sources (in the example just given, FACEBOOK™).

In this manner, it can be appreciated that analysis can be considered to be infinitely-scalable—that is, it can always be “zoomed out” to encompass additional data and improve results, and may be seen to be constantly evolving and improving over time with additional data collection and analysis operations. Whenever a new characteristic or relationship is revealed, it may be incorporated into future analysis operations to improve their results and uncover any additional information that may have previously gone unnoticed due to ignorance of the data involved. For example, continuing a prior example, if a new hire is seen to have a different effect than anticipated and it is revealed to be due to a previously unknown or unaccounted-for characteristic, this new data may then be used to perform analysis on previous groups or employees to uncover any additional relationships due to this newly-discovered variable.

With regards to an analysis operation, analysis may vary widely in nature and scope (as described previously). For example, data might be analyzed not only for point-to-point relationships between metrics or individuals (such as “individuals displaying metric X have performance indicator Y”), but also to observe trends or patterns such as changes over time, changes in various metrics that might be triggered by other changes (such as “if metric X is changed, metric Y changes in this fashion”). Additionally, by incorporating social networks or other third-party services as described previously, it becomes possible to perform various analysis of such information to add to the complexity and relevancy of results. For example, in addition to a simple analysis of keywords, profile data, and other specific data points, an individual's social networking information may be analyzed for traffic patterns (who visits their profile, how often, how did they find it, or any other of a wide variety of potential information related to internet traffic), structure of their social networking connection (such as how many people they are connected to and how they are connected, how strong these connections are, or other such data related to social networking relationships or structure), specific known performance indicators such as particular vocabulary (such as frequency of profanity, or use of specific phraseology that may have been observed to be related to performance in prior analysis), or broad personality traits or behavior patterns (such as whether an individual is “careful” or a “risk taker”, “introverted” or “outgoing”, or the overall “tone” of their interactions with other individuals, or any other such personality or behavior identifiers that may become apparent via analysis). It should be further appreciated that such complex analysis may be improved over time, as more data is collected and more connections are observed or inferred, or as new information is acquired with regard to previous analysis results or predictions (such as learning that predicted results based on a particular metric or social network did not match later observed results). In this manner such analysis may be seen as adaptive, in that it may utilize machine learning to continually improve operation and results by incorporating past and current data for consideration, constantly increasing in relevancy and precision. It may also be seen that the granularity and scope of any particular analysis operation may vary, from very general to very specific, according to the nature of a particular analysis operation.

In this way, such a workforce management system 510 may be seen to be modular in that it allows for the use of both new and existing systems and services to enhance and optimize function, while at the same time providing standalone functionality that may be seen to enhance management and operation of a workforce.

### DETAILED DESCRIPTION OF EXEMPLARY EMBODIMENTS

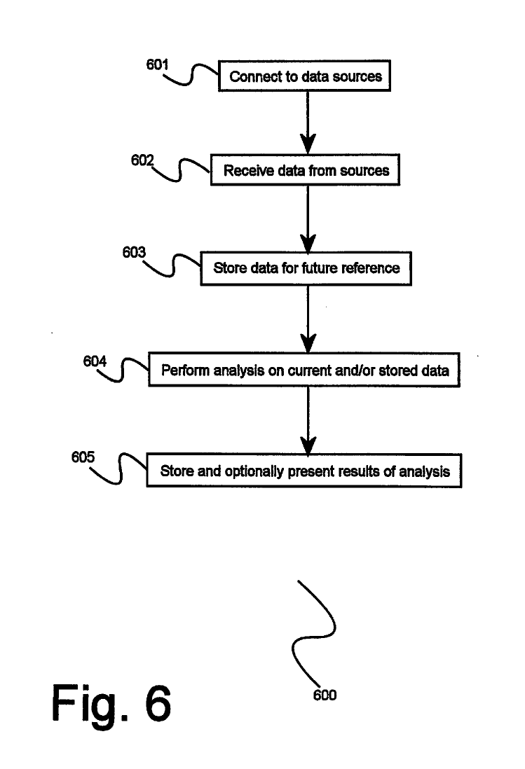

FIG. 6 is a method flow diagram illustrating an exemplary method 600 for providing adaptive workforce analytics, according to a preferred embodiment of the invention. In an initial step 601, a workforce management system may connect to a plurality of data sources such as internal or external workforce monitoring systems (such as, as described previously, call recording or performance measurements systems as are common in the art, or external third-party systems such as social networking services). In a second step 602, data may be received or collected from data sources, and it should be appreciated that such collection may be performed in either a passive (that is, data is sent or broadcast from a source to be received by a workforce management system), or active (that is, a workforce management system requests data from sources to which they may respond by providing data) manner, according to a particular arrangement.

In a next step 603, data received may be stored for future reference, such as in a database or physical storage media as may be appropriate according to a particular arrangement. In this manner, data may be kept available for use in comparisons (i.e., comparing previously data with current data to identify changes or trends), such as during an analysis operation that may be performed in a next step 604. Such analysis may be used to identify data changes or similarities, trends and patterns that may be observed such as by comparing with previously-stored historical data in a previous step 603, or to identify potential matches for hire candidates such as by comparing stored data (for example, traits or metrics recorded from known top performers may be compared with data received from potential candidates to identify desirable matches). In a final step 605, results of analysis operations may be stored for future reference (such as to maintain a repository of analysis results for processing by a human analyst), and may be optionally presented to an analyst for immediate review.

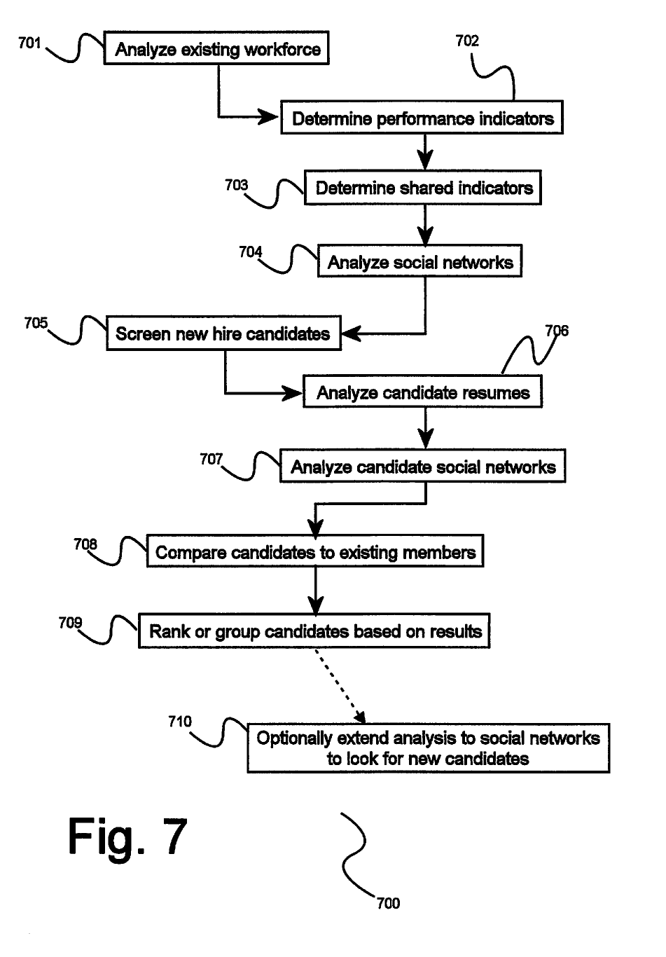

FIG. 7 is a method flow diagram illustrating an exemplary high-level process 700 for adaptive analysis operation, according to the invention. In an initial step 701, an analysis operation may be performed on an existing workforce. This may be an entire employee pool, a subset or group of employees, specific individuals, or any other arrangement of workforce members according to the nature of a particular analysis being performed. In a next step 702, these workforce members may be analyzed to determine performance indicators, such as simple one-to-one correlations between observed data (such as age, gender, what shift they work, or any other single data point that may be observed or determined through analysis) and performance metrics (such as call handle time, customer satisfaction, number of successful sales, or any other relevant indicator of employee performance), or it may be a more complex association such as determining connections between multiple data points and performance, or determining connections between groups or subsets of employees that may not be immediately visible when considering only single data points (such as, for example, determining that employees who work a 9-to-5 shift AND are between the ages of 35-45 are more likely to be punctual than employees who share only one of those two data points).

In a next step 703, members may then be analyzed to determine shared characteristics, such as might indicate further correlations between performance and observed data. For example, a group of member may be observed to be high performers, and then analyzed to identify traits they have in common, or how they might be related or otherwise connected to each other. Furthermore, members may be optionally grouped according to analysis results, for example categorizing or sorting members based on shared characteristics or observed information (such as grouping high performers together, or grouping together employees that share specific characteristics or groups of characteristics), as might be used to aid in future analysis operations (such as analyzing particular subsets of a workforce).

In a next step 704, member social networks (or other third-party services) may be analyzed such as to determine behaviors or characteristics that may be further utilized in analysis, such as their behavior online or when on “personal time”, or other such data points that may not ordinarily be available to an employer for consideration. In this manner, analysis may reveal more relevant and complex relationships than ordinarily possible through traditional methods.

In a next step 705, potential candidates for hire may be screened using adaptive analysis, such as to determine their anticipated value or performance prior to making a hiring decision. In a next step 706, candidate resumes may be analyzed such as (for example) to compare to the resumes of existing employees known to have desirable characteristics or high performance, or to compare to known information about existing employees. Such analysis might be used to form a prediction of an individual candidate's likely performance or value to the employer, based on such factors as their similarities or relationships with existing employees or groups of employees (such as determining whether they display similar sets of characteristics that, based on previous analysis described above, may have been determined to be indicative of success).

In a next step 707, candidate's social networking profiles or postings may be analyzed, such as to determine their behavior in other areas or to analyze personal information or behaviors as described previously. Such analysis might reveal further similarities or differences with existing employees analyzed in a previous step, or reveal additional information not immediately available based on a candidate's resume alone (such as observing that information given in a resume does not match information given in their social network profile, which might indicate that a candidate is lying about their credentials or other information, making them less desirable for hire). In a next step 708, analysis results of candidates may be compared to results from existing employees (as may have been determined in previous steps), such as to identify similarities between candidates and existing employees to form an idea of their predicted performance or value to the employer. Additionally, candidate social networking information may be compared to social networking information of existing employees to further identify any similarities or correlations, such as possibly revealing relationships between candidates and existing members (for example, a current employee known to be a high performer may have recommended that their friend turn in a resume for consideration, which might make that friend more desirable based on the quality of the existing employee's work).

In a next step 709, candidates may be ranked or grouped based on analysis results, such as to make more desirable candidates available for consideration without spending time reviewing candidates that may have been revealed to be undesirable through analysis (thereby saving time and increasing the efficiency of the hiring process).

In an optional step 710, additional analysis may be performed on social networking profiles such as those made available by analyzing existing employees and potential candidates. Such analysis may be used to analyze other individuals outside the “pool” of individuals considered in previous analysis steps (i.e., existing employees and individuals who turned in resumes for consideration), such as to find promising candidates through social network analysis regardless of whether they may have presented a resume or expressed an interest in candidacy. In this manner, an adaptive analysis operation may be used for proactively seeking out desirable candidates or “headhunting” prospective employees, further improving the results of any particular hiring process.

In some embodiments, “elearning” or automated training tools may be integrated with other elements of the invention, in order that candidates may be provided some initial elearning modules to perform (i.e., to study from and be tested by). The results of such elearning modules can be used as part of the candidate screening process (for example, by identifying candidates who have difficulty using elearning methods, or those who are quick, decisive, and correct in their use of the modules—indicating likely high performance). Such early use of elearning can also help to improve the level of engagement between candidates and an enterprise, so that candidates are more committed to the enterprise than to other, less interactive and responsive, potential sources of work. Moreover, elearning can be part of the onboarding process for candidates as well, thereby not only informing new hires of key policies and procedures but also assessing their skills in order to automatically place them in an appropriate training regimen. Moreover, such early and integrated use of elearning in the hiring and onboarding processes will simultaneously serve to ramp up individuals' familiarity and proficiency with selected elearning platforms, but will also start the process of gathering rich behavioral data on each individual as early as possible, so that training, skill assessment and assignment, and work assignments can be made in a data-centric way from the very beginning. Finally, integrated elearning, along with the other elements of the invention, will also tend to dramatically improve the productivity of the hiring process, both from the enterprise's perspective and from that of potential new hires.

The skilled person will be aware of a range of possible modifications of the various embodiments described above. Accordingly, the present invention is defined by the claims and their equivalents.

What is claimed is:

1. A system for adaptive workforce analytics, comprising:
a web server stored and operating on a network-connected device;
an application server stored and operating on a network-connected device;
an analysis server stored and operating on a network-connected device; and
a database.
wherein the web server receives interactions from users via a communications network;
wherein the application server provides software means for user interaction;
wherein the analysis server receives and analyzes data via a communications network; and
wherein the database stores analysis results for future reference.

2. The system of claim 1, further wherein the application server provides interactive means for configuring the operation of the analysis server.

3. The system of claim 1, further wherein the data received by the analysis server is resume data.

4. The system of claim 1, further comprising an eLearning module, wherein the eLearning module provides interactive content to users.

5. The system of claim 4, further wherein the analysis server scores users based at least in part on their interactions with eLearning content.

6. A method for adaptive workforce analytics, comprising the steps of:
connecting to a plurality of data sources via a communications network;
receiving data from the data sources;
storing the received data;
analyzing the received data; and
storing the analysis results.

7. The method of claim 6, further comprising the step of providing eLearning material for interaction via the communications network.

8. The method of claim 7, further comprising the step of analyzing the results of user interaction with the eLearning material.
